(19) United States
(12) Patent Application Publication
(10) Pub. No.: US 2023/0142961 A1
(43) Pub. Date: May 11, 2023

(54) NON-TANGLING DOG LEASH

(71) Applicant: DogWare LLC, Barrington Hills, IL (US)

(72) Inventors: Narayan Richard Tripathy, Barrington, IL (US); Michael James Lindh, North Barrington, IL (US); Kate Ashleigh Lubinsky, Barrington, IL (US); Regan Lynne Albertson, South Barrington, IL (US); Zachary Laurence Witt, Lakewood, IL (US); Daniel Andrew Hudzik, Des Plaines, IL (US); Grace Catherine Lyman, Buffalo Grove, IL (US); Kushal Amilineni, Telangana (IN)

(73) Assignee: DogWare LLC, Barrington Hills, IL (US)

(21) Appl. No.: 17/681,795

(22) Filed: Feb. 27, 2022

Related U.S. Application Data
(60) Provisional application No. 63/277,541, filed on Nov. 9, 2021.

(51) Int. Cl. A01K 27/00

(52) U.S. Cl. CPC A01K 27/003

(57) ABSTRACT

A dog leash that prevents tangling between a dog's legs. The dog leash has a flexible cord with a handle at a first end, a fastener at a second end for refastenably connecting the flexible cord to a collar, and a stiffening agent applied to an exterior surface of the flexible cord along a partial length of the flexible cord near the second end.

### FIELD OF THE INVENTION

The invention relates to a dog leash that prevents tangling between the dog's legs, and a method of producing the dog leash.

### BACKGROUND OF THE INVENTION

When taking a dog for a walk, the leash often gets tangled between or around the dog's legs. This problem is particularly prevalent when the leash is long, but can also occur with shorter leashes. Sometimes the dog owner does not notice the entanglement right away, which can be not only annoying to the dog, but dangerous as well, as the entanglement can cause the dog to trip, or reduce circulation in the dog's body.

U.S. Pat. No. 5,291,856 issued to Goller provides a solution to this problem by applying stiffening means to the leash in the form of a coiled member or a rigid shaft attached to the leash or an insert extending interiorly along the distal end of the leash. The stiffening means minimizes the tendency of the leash to become slack and entangled beneath the dog's body. However, each of these remedies has a drawback of being difficult to manufacture, or being too rigid, and/or being just plain uncomfortable.

There is a need or desire for a dog leash that does not get tangled between the dog's legs, is easy to manufacture, and provides enough flexibility to be comfortable during use.

### SUMMARY OF THE INVENTION

The object of the invention, therefore, is to provide a dog leash that prevents tangling between the dog's legs without being overly rigid. Another object of the invention is to provide a method of making a dog leash that prevents tangling between the dog's legs without being overly rigid. These objects are achieved by applying a stiffening agent to an exterior surface of a flexible cord along a partial length of the flexible cord near an end that can be refastenably connected to the dog's collar. The stiffening agent can be either heat shrink tubing or a rubber coating.

### BRIEF DESCRIPTION OF THE DRAWINGS

FIG. 1 is a perspective view of one embodiment of a dog leash.

FIG. 2 is a perspective view of another embodiment of a dog leash.

FIG. 3 is a perspective view of yet another embodiment of a dog leash.

FIG. 4 is a perspective view of still another embodiment of a dog leash.

FIG. 5 is a perspective view of still another embodiment of a dog leash.

FIG. 6 is a perspective view of still another embodiment of a dog leash.

### DETAILED DESCRIPTION OF THE PREFERRED EMBODIMENTS

A dog leash that prevents tangling between the dog's legs can be achieved by applying a stiffening agent to an exterior surface of a flexible cord along a partial length of the flexible cord near an end that can be refastenably connected to the dog's collar. The flexible cord may be any suitable dog leash material, such as a woven material, leather, cotton, nylon or other polymer, which may be either braided or flat, or have any suitably shaped cross-section. The flexible cord may be any suitable length, such as between 2 and 16 feet, or between 3 and 10 feet, or between 4 and 6 feet. For example, according to certain embodiments, the flexible cord may be 4 feet, 5 feet, or 6 feet long. The flexible cord may be formed of a single material, or a combination of two or more materials. For example, a first material extending from the first end, which may have a length between 1 and 6 feet, may be a lighter weight material than a second material extending from the second end, which may also have a length between 1 and 6 feet. The flexible cord preferably has a handle at a first end, such as in the form of a loop, and a fastener at a second end, such as a swivel fastener, for refastenably connecting the flexible cord to the dog's collar or harness.

One suitable type of stiffening agent is heat shrink tubing. The heat shrink tubing may be in the form of a single tube that can be fitted over the flexible cord and, through the application of heat, shrunk to fit the flexible cord. Alternatively, a plurality of overlapping pieces of heat shrink tubing may be fitted over the flexible cord and shrunk to fit the flexible cord.

In embodiments that include a single tube of heat shrink tubing, the single tube may be between about 6 inches and about 4 feet long, or between about 1 foot and about 3 feet long, depending on the length of the flexible cord. According to certain embodiments, the single tube of heat shrink tubing may cover between about 5% and about 60% of the length of the flexible cord, or between about 10% and about 50% of the length of the flexible cord, or between about 15% and about 40% of the length of the cord, again, depending on the length of the flexible cord.

Similarly, in embodiments that include a plurality of overlapping pieces of heat shrink tubing, the heat shrink tubing, once applied to the flexible cord, may cover a length between about 6 inches and about 4 feet, or between about 1 foot and about 3 feet. According to certain embodiments, the plurality of overlapping pieces of heat shrink tubing may cover between about 5% and about 60% of the length of the flexible cord, or between about 10% and about 50% of the length of the flexible cord, or between about 15% and about 40% of the length of the cord.

Another suitable type of stiffening agent is a rubber coating, such as a rubber dip, into which the flexible cord may be dipped, or which may be painted onto the exterior surface of the flexible cord and allowed to dry. Like the heat shrink tubing, the rubber coating may also cover a length of the flexible cord between about 6 inches and about 4 feet, or between about 1 foot and about 2 feet. According to certain embodiments, the rubber coating may cover between about 5% and about 60% of the length of the flexible cord, or between about 10% and about 50% of the length of the flexible cord, or between about 15% and about 30% of the length of the cord.

Both of these types of stiffening agent, namely the heat shrink tubing and the rubber coating, when applied to an exterior surface of the flexible cord, provide sufficient stiffness to prevent the leash from becoming tangled around or between a dog's legs, while maintaining sufficient flexibility to be comfortable for both the dog and the dog owner. If the stiffening agent is too rigid, the dog owner may feel as though the stiffening agent is pushing the dog away from the owner unnecessarily. The heat shrink tubing and the rubber coating provide enough flexibility to allow the dog and owner to be close to one another, but without the slack in the leash that would lead to entanglement of the leash around the dog's legs.

As an added bonus, when using a stiffening agent that is non-toxic, the stiffening agent doubles as a reinforcement of the flexible cord. Many dogs tend to chew on their leash, which can cause the leash to break. The reinforcement of a non-toxic stiffening agent can withstand chewing to a greater extent than the leash alone. The stiffening agent in the form of either a heat shrink tubing or rubber coating is much more durable and safer than other stiffening means, such as a coiled member, rigid shaft, or an insert extending interiorly along the distal end of the leash. Another benefit provided by the heat shrink tubing and rubber coating is the cleanliness factor. The heat shrink tubing and rubber coating provide a smooth surface that prevents dirt from getting trapped within the stiffening agent, and the surface of the stiffening agent is easy to clean.

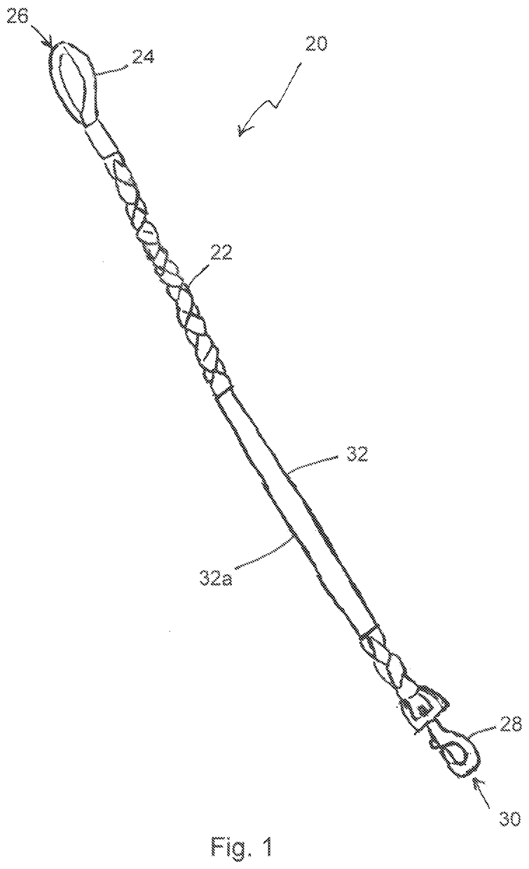

FIGS. 1 through 6 illustrate various embodiments of the dog leash 20. Each of the embodiments includes a flexible cord 22 having a handle 24 at a first end 26 and a fastener 28 at a second end 30 for refastenably connecting the flexible cord 22 to a collar or harness. Each of the embodiments also includes a stiffening agent 32 applied to an exterior surface of the flexible cord 22 along a partial length of the flexible cord 22 near the second end 30.

FIG. 1 shows a dog leash 20 including a flexible cord 22 in the form of a braided leash. In longer embodiments, such as 5- and 6-foot long leashes, the flexible cord 22 may consist of two strands of heavyweight polypropylene that are wrapped around each other. In shorter embodiments, such as 4-foot long leashes, the flexible cord 22 may consist of two strands of lightweight polypropylene wrapped around one another. The handle 24 is at the first end 26. The fastener 28 at the second end 30 is a swivel clip that allows rotation between the collar and the leash 20 in order to prevent the leash 20 from becoming twisted. The stiffening agent 32 is heat shrink tubing 32a. The heat shrink tubing 32a is in the form of a single tube fitted over the flexible cord 22 and, through the application of heat, shrunk to fit the flexible cord 22. The heat shrink tubing 32a provides exceptional durability with sufficient stiffness to prevent the leash from getting entangled around or between the dog's legs.

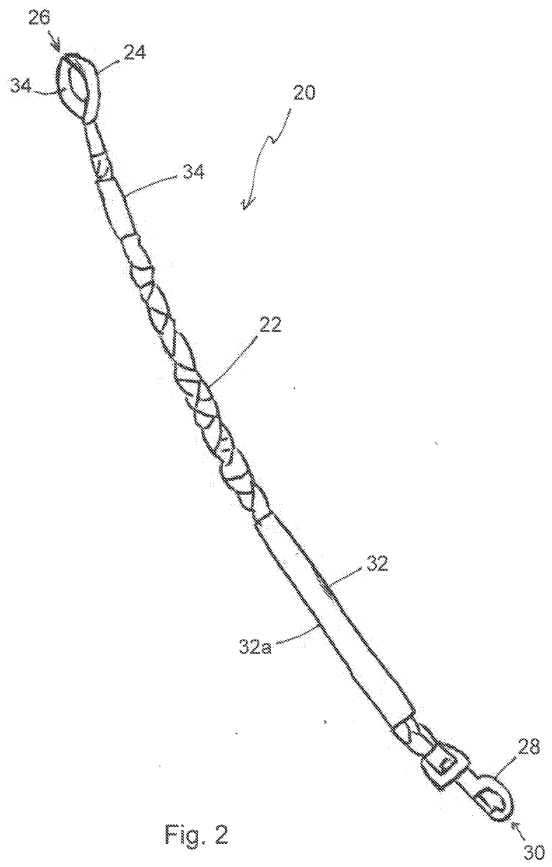

To further enhance a user's grip on the leash 20 and to provide greater comfort to the dog owner handling the leash 20, according to certain embodiments, a rubber coating or rubber material 34, such as neoprene, may be applied to an interior surface of the loop handle 24. FIG. 2 shows the dog leash 20 of FIG. 1 with the rubber material 34 applied to the interior surface of the handle 24. Additionally or alternatively, a rubber coating or rubber material 34, such as neoprene, may be applied to the exterior surface of the flexible cord 22 along a partial length of the flexible cord 22 near the handle 24, also shown in FIG. 2. This application of the rubber material 34 provides the dog owner an alternative gripping option to better control their dog. For example, the rubber coating or rubber material 34 may be applied along a length of 3 to 12 inches, or 4 to 8 inches, of the flexible cord 22. The rubber coating or rubber material 34 may be applied to the flexible cord 22 starting at the base of the handle 24, or starting between 1 and 12 inches below the base of the handle 24.

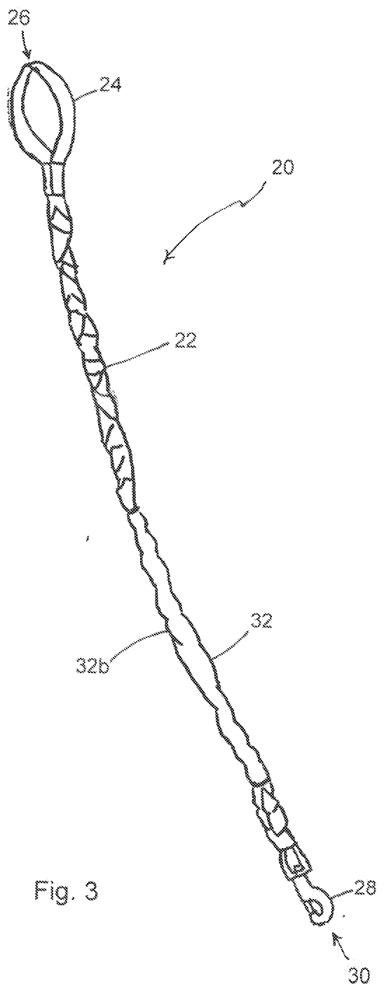

The dog leash 20 in FIG. 3 also includes a flexible cord 22 in the form of a braided leash. The handle 24 is at the first end 26. The fastener 28 at the second end 30 is a swivel clip that allows rotation between the collar and the leash 20 in order to prevent the leash 20 from becoming twisted. The stiffening agent 32 in this embodiment is applied as a liquid rubber dip, which dries to form a rubber coating 32b. The flexible cord 22 may be dipped into the rubber dip or the rubber dip may be painted onto the exterior surface of the flexible cord 22 and allowed to dry in order to form the rubber coating 32b. The rubber coating 32b provides flexibility with less stiffness compared to heat shrink tubing 32a.

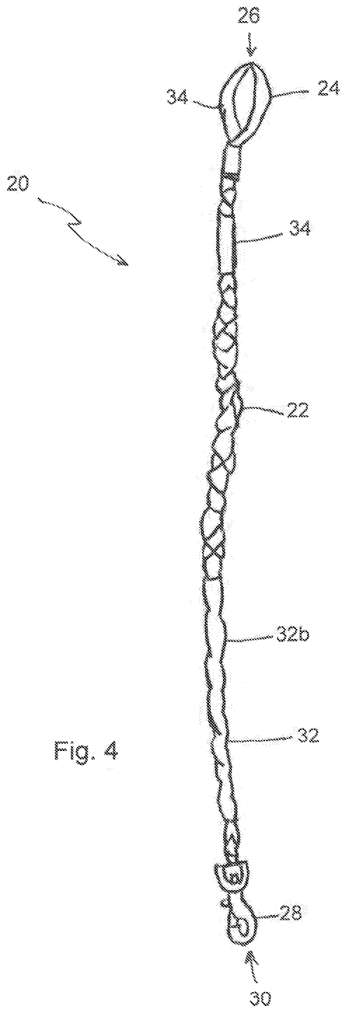

FIG. 4 shows the dog leash 20 of FIG. 3 with the rubber material 34 applied to the interior surface of the handle 24 as well as to the exterior surface of the flexible cord 22 along a partial length of the flexible cord 22 near the handle 24. As explained above, the application of the rubber material 34 provides the dog owner a more comfortable grip as well as an alternative gripping option.

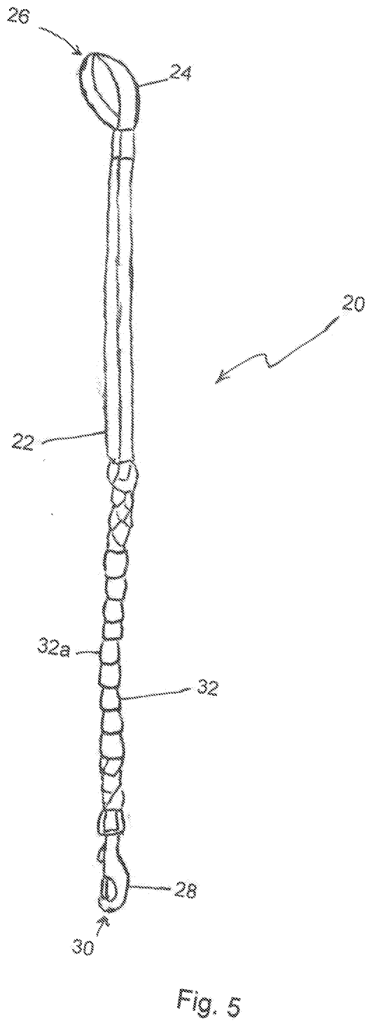

The dog leash 20 in FIG. 5 also includes a flexible cord 22 in the form of a layered woven leash extending from the handle 24 combined with a braided leash that extends toward the second end 30. The handle 24 is at the first end 26. The fastener 28 at the second end 30 is a swivel clip that allows rotation between the collar and the leash 20 in order to prevent the leash 20 from becoming twisted. The stiffening agent 32 in this embodiment is applied as a plurality of overlapping pieces of heat shrink tubing 32a. The individual pieces of heat shrink tubing 32a may have a length between about 2 inches and 12 inches, or between about 3 inches and 5 inches. The relatively small lengths of heat shrink tubing 32a may be easier to source, and the overlapping lengths may provide greater durability and greater stiffness compared to a single piece of heat shrink tubing 32a.

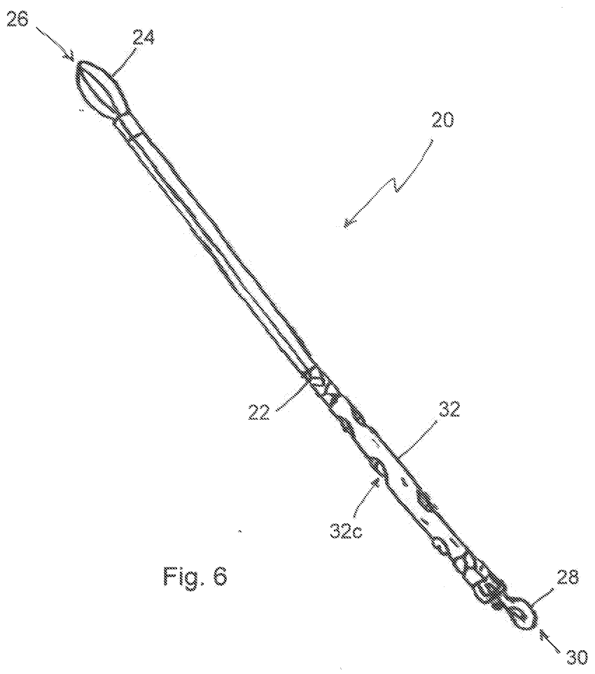

The dog leash 20 in FIG. 6 is similar to the dog leash in FIG. 5, but the stiffening agent in FIG. 6 is a perforated heat shrink tubing 32c. The perforated heat shrink tubing 32c provides flexibility with less stiffness and lighter weight compared to solid heat shrink tubing 32a.

Additional elements may be added to the dog leash 20. For example, one or more reflective strips may be applied to the exterior surface of the flexible cord 22, or to an exterior surface of the stiffening agent 32, as a safety feature when walking the dog in the dark. As another example, text, such as the dog's name, and/or a graphical design or logo, may be applied to the exterior surface of the flexible cord 22 or stiffening agent 32.

A method of producing the dog leash 20 includes obtaining a flexible cord 22 having a handle 24 at the first end 26 and a fastener 28 at the second end 30 for refastenably connecting the flexible cord 22 to a collar. Application of the stiffening agent is simple and straightforward. More particularly, the stiffening agent can be applied to an exterior surface of the flexible cord 22 along a partial length of the flexible cord 22 near the second end 30. When using a heat shrink tubing 32a as the stiffening agent 32, heat must be applied to the heat shrink tubing 32a after applying the heat shrink tubing 32a to the exterior surface of the flexible cord 22. When using a rubber dip to form a rubber coating 32b, the flexible cord 22 may be dipped into the rubber dip or the rubber dip may be painted onto the exterior surface of the flexible cord 22 and allowed to dry in order to form the rubber coating 32b. A rubber material, such as neoprene, can be applied to an interior surface of the loop-shaped handle and/or to the exterior surface of the flexible cord along a partial length of the flexible cord near the handle.

### Examples

Example 1: In this example, best illustrated in FIG. 2, the dog leash is 5 feet long. The leash includes a four-piece fully braided woven dog leash coated around a lower portion with Techflex Shrinkflex 2:1 Fabric Heat-Shrink Tubing, available from Summit Racing Equipment of Tallmadge, Ohio. The Shrinkflex tubing is 2 feet long and holds its stability at the bottom of the leash, thus preventing the leash from tangling between the dog's legs. There is a swivel clip at the end of the lower portion of the leash, which enables a user to attach the leash to the dog's collar. Neoprene material, specifically Sponge Neoprene ⅛-inch thick, 54-inches wide, available from Amazon, has also been added within the loop of the grip, and to 6 inches of the length of the leash just below the loop of the grip. The neoprene allows comfortability for the owner when controlling their dog. The neoprene also gives the dog owner an alternative gripping option to better control their dog. Below the loop of the grip, there is also room to potentially add reflective strips and/or company branding.

Example 2: In this example, best illustrated in FIG. 2, the dog leash is 5 feet long. The bottom of the leash is a four-piece fully braided leash coupled with a 2-foot length of heat shrink tubing, particularly 3:1 WaterProof Heat Shrink Tubing, available from Amazon, which covers a partial length of the braided leash. The heat shrink tubing holds its stability at the bottom of the leash, thus preventing the leash from tangling between the dog's legs. There is a swivel clip at the end of this portion of the leash, which enables a user to attach the leash to the dog's collar. Neoprene material, specifically Sponge Neoprene ⅛-inch thick, 54-inches wide, available from Amazon, has also been added within the loop of the grip, and to 6 inches of the length of the leash just below the loop of the grip. The neoprene allows comfortability for the owner when controlling their dog. The neoprene also gives the dog owner an alternative gripping option to better control their dog. Below the loop of the grip, there is also room to potentially add reflective strips and/or company branding.

Example 3: In this example, best illustrated in FIG. 4, the dog leash is 5 feet long. The leash includes a four-piece fully braided woven dog leash coated around a lower portion with Rubberize It Dura-Rubber rubber dip, available from www.rubberizeit.com. The rubber dip covers 2 feet of the leash and holds its stability, thus preventing the leash from tangling between the dog's legs. The strength and flexibility of the rubber dip allows the leash to be easily stored in drawers or small compartments. There is a swivel clip at the end of the lower portion of the leash, which enables a user to attach the leash to the dog's collar. Neoprene material, specifically Sponge Neoprene ⅛-inch thick, 54-inches wide, available from Amazon, has also been added within the loop of the grip, and to 6 inches of the length of the leash just below the loop of the grip. The neoprene allows comfortability for the owner when controlling their dog. The neoprene also gives the dog owner an alternative gripping option to better control their dog. Below the loop of the grip, there is also room to potentially add reflective strips and/or company branding.

Example 4: In this example, illustrated in FIG. 5, the dog leash is 5 feet long. The bottom of the leash is a four-piece braided leash coupled with heat shrink tubing. These parts are purposely heavier to hold its shape and stability. The coupled heat shrink tubing is formed of 4-inch pieces of 3:1 WaterProof Heat Shrink Tubing, available from Amazon, put over each other, adding up to a total length of 2 feet of heat shrink tubing covering a partial length of the braided leash. This portion allows the leash to stay stiff during the dog walking process, and it easy to store. There is a swivel clip at the end of this portion of the leash, which enables a user to attach the leash to the dog's collar. The other half of the leash is a basic flexible, flat, nylon material. This part is far lighter and brings down the total weight of the leash. On this half of the leash, there is also room to potentially add reflective strips and/or company branding.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A dog leash, comprising:
a flexible cord having a handle at a first end and a fastener at a second end for refastenably connecting the flexible cord to a collar; and
a stiffening agent applied to an exterior surface of the flexible cord along a partial length of the flexible cord near the second end.

2. The dog leash according to claim 1, wherein the stiffening agent is heat shrink tubing.

3. The dog leash according to claim 2, wherein the heat shrink tubing comprises a plurality of overlapping pieces of heat shrink tubing fitted over the flexible cord and shrunk to fit the flexible cord.

4. The dog leash according to claim 2, wherein the heat shrink tubing comprises a single tube fitted over the flexible cord and shrunk to fit the flexible cord.

5. The dog leash according to claim 2, wherein the heat shrink tubing is perforated.

6. The dog leash according to claim 1, wherein the stiffening agent is a rubber coating.

7. The dog leash according to claim 1, wherein the flexible cord comprises at least one of the group consisting of a braided cord, a flat cord, a nylon cord, and a woven cord.

8. The dog leash according to claim 1, wherein the flexible cord comprises a first material extending from the first end and a second material extending from the second end, wherein the first material is lighter weight than the second material.

9. The dog leash according to claim 1, further comprising at least one reflective strip applied to the exterior surface of the flexible cord.

10. The dog leash according to claim 1, further comprising text and/or a graphical design applied to the exterior surface of the flexible cord.

11. The dog leash according to claim 1, wherein the handle comprises a loop, and further comprising a rubber material applied to an interior surface of the loop.

12. The dog leash according to claim 1, further comprising a rubber material applied to the exterior surface of the flexible cord along a partial length of the flexible cord near the handle.

13. A method of producing a dog leash, comprising:
obtaining a flexible cord having a handle at a first end and a fastener at a second end for refastenably connecting the flexible cord to a collar; and
applying a stiffening agent to an exterior surface of the flexible cord along a partial length of the flexible cord near the second end.

14. The method according to claim 13, wherein the stiffening agent is a heat shrink tubing, and further comprising applying heat to the heat shrink tubing after applying the heat shrink tubing to the exterior surface of the flexible cord.

15. The method according to claim 13, wherein the stiffening agent is a rubber coating.

16. The method according to claim 13, wherein the handle comprises a loop, and further comprising applying a rubber material to an interior surface of the loop.

17. The method according to claim 13, further comprising applying a rubber material to the exterior surface of the flexible cord along a partial length of the flexible cord near the handle.
